(19) United States
(12) Patent Application Publication
(10) Pub. No.: US 2021/0382695 A1
(43) Pub. Date: Dec. 9, 2021

(54) METHOD FOR GENERATING RANDOM SEQUENCE USING EXPONENTIAL FUNCTION AS RANDOM NUMBER SOURCE

(71) Applicant: I-SHOU UNIVERSITY, Kaohsiung City (TW)

(72) Inventors: HO-HSUAN CHANG, Kaohsiung City (TW); SHIH-CHIANG LIN, Kaohsiung City (TW)

(73) Assignee: I-SHOU UNIVERSITY, Kaohsiung City (TW)

(21) Appl. No.: 16/985,298

(22) Filed: Aug. 5, 2020

(30) Foreign Application Priority Data
Jun. 9, 2020 (TW) 109119245

(51) Int. Cl. G06F 7/58; G06F 7/556

(52) U.S. Cl. CPC G06F 7/588; G06F 7/556

(57) ABSTRACT

A method for generating a random sequence using an exponential function as a random number source, including: providing an exponential function a^{b}, wherein, the base a is an integer, and the exponent b is an integer; expanding a value of the exponential function into a first preliminary sequence in decimal; and using the first preliminary sequence as a random number source to generate a random sequence.

### CROSS-REFERENCE TO RELATED APPLICATIONS

The present invention claims priority to Taiwan Patent Application No. 109119245 filed on Jun. 9, 2020, which is incorporated herein by reference for all purposes.

### FIELD OF THE INVENTION

The present invention relates to a method for generating a random sequence, in particular to a method for generating a random sequence using an exponential function as a random number source.

### BACKGROUND OF THE INVENTION

Random number generator (RANG) is the key component of security systems. Random codes and random sequences have long been widely used in cryptography, system simulation, and various communication security purposes, and have appeared in a variety of application scenarios, such as in the video game as program generation. At the same time, the technology of random codes or random numbers is closely related to the research of noise. Noise is an unavoidable subject of communication systems. For this reason, all instrument manufacturers are all committed to developing noise simulators. When the noise spectrum generated by the instrument is more evenly distributed, it means that it is closer to the real nature. This technical means has a critical impact on the development of related instrument equipments.

RANG is currently an indispensable part of encryption systems and coding. In the past, random number generation methods mainly included algorithm generation and physical hardware generation. The algorithm generation is to use the pseudo-random number generator (PRNG) mathematical method to generate random numbers. However, the random numbers generated by PRNG can be easily decrypted because there exists correlation between the sequences and the length of a sequence may not be flexible. The hardware random number generator (HRNG) is generated through unpredictable physical phenomena such as ferroelectric field effect transistors. However, the HRNG method must have sufficient time for the hardware components to reflect the required physical characteristics, which is very time-consuming and is not suitable for use in today's high-speed communication systems. Although the physical hardware generation method can achieve high level of randomness, however, there are still technical challenges to be solved before the actual application of HRNG.

### BRIEF SUMMARY OF THE INVENTION

An object of the present invention is to provide a method for generating a random sequence using an exponential function as a random number source, such that each number in the generated random sequence approaches a natural random number.

Another object of the present invention is to provide a method for generating a random sequence using an exponential function the random number source, such that the random number source can be generated repeatedly.

To achieve above and other objects, an embodiment of the present application provides a method for generating a random sequence using an exponential function as a random number source, comprising: providing an exponential function a^{b}, wherein, the base a is an integer, and the exponent b is an integer; expanding a value of the exponential function into a first preliminary sequence in decimal; and using the first preliminary sequence as a random number source to generate a random sequence.

To achieve above and other objects, a further embodiment of the present application provides a method for generating a random sequence using an exponential function as the random number source, providing at least two sets of exponential functions mⁿ and x^{y}, wherein, the base m and the base x are integers, and the exponent n and the exponent y are integers; expanding a value of mⁿ and a value of x^{y} into a first sequence and a second sequence in decimal, respectively; concatenating the first sequence and the second sequence into a second preliminary sequence; and using the second preliminary sequence as a random number source to generate a random sequence.

The base a is a positive integer, and the exponent b is a positive integer.

The number of digits in the first preliminary sequence is at least 90 digits.

The method further comprises performing a binary code conversion on the decimal numbers of the first preliminary sequence, wherein the odd digits in the first preliminary sequence are transformed into “1” and the even digits in the first preliminary sequence are transformed into “0”, such that the first preliminary sequence is converted into a first binary code sequence; and replacing the first preliminary sequence with the first binary code sequence as the random number source to generate the random binary code sequence.

Alternatively, the method further comprises performing a binary code conversion on the decimal numbers of the first preliminary sequence, wherein the odd digits in the first preliminary sequence are transformed into “0” and the even digits in the first preliminary sequence are transformed into “1”, such that the first preliminary sequence is converted into a first binary code sequence; and replacing the first preliminary sequence with the first binary code sequence as the random number source to generate the random binary code sequence.

The base m and the base x are positive integers, and the exponent n and the exponent y are positive integers.

An order in which the first sequence and the second sequence are concatenated may be interchanged.

A number of digits in the second preliminary sequence is at least 90 digits.

The method further comprises performing a binary code conversion on the decimal numbers of the second preliminary sequence, wherein the odd digits in the second preliminary sequence are transformed into “1” and the even digits in the second preliminary sequence are transformed into “0”, such that the second preliminary sequence is converted into a second binary code sequence; and replacing the second preliminary sequence with the second binary code sequence as the random number source to generate the random binary code sequence.

Alternatively, the method further comprises performing a binary code conversion on the decimal numbers of the second preliminary sequence, wherein the odd digits in the second preliminary sequence are transformed into “0” and the even digits in the second preliminary sequence are transformed into “1”, such that the second preliminary sequence is converted into a second binary code sequence; and replacing the second preliminary sequence with the second binary code sequence as the random number source to generate the random binary code sequence.

### BRIEF DESCRIPTION OF DRAWINGS

Not applicable.

### DETAILED DESCRIPTION OF THE INVENTION

An embodiment of the present application provides a method for generating a random sequence using an exponential function as a random number source, comprising: providing an exponential function a^{b}, wherein, the base a is an integer, and the exponent b is an integer; expanding a value of the exponential function into a first preliminary sequence in decimal; and using the first preliminary sequence as a random number source to generate a random sequence.

For example, if the base a is 8 and the exponent b is 15, the exponential function a^{b} may be expressed as 8¹⁵. The value of the exponential function is expanded to 1152921504606850000 in decimal representation, and then {1152921504606850000} is set as a first preliminary sequence. Since the value of the exponential function is expanded in decimal expression, each value will appear in an irregular manner, which is very suitable for using as random number source. Finally, the first preliminary sequence is used as a random number source to generate a random sequence, and the required number is selected from the first preliminary sequence as a random sequence according to requirements.

Preferably, the base a is a positive integer, and the exponent b is a positive integer. Regardless of whether the base a or the exponent b is a negative integer, the operations to exponents are relatively complicated, thus in order to make the value of the exponential function a^{b} relatively easy to perform operations when presented in decimal, both the base a and the exponent b are preferably positive integers.

Preferably, the number of digits in the first preliminary sequence may be at least 90 digits. In order to make the first preliminary sequence appearing closer to a natural random number, such that each number of the first preliminary sequence appears more naturally, when the value of the exponential function a^{b} is presented in decimal, the number of digits in the first preliminary sequence may be at least 90 digits. In this embodiment, when the exponential functions a^{b}=5¹²³, the values after expanding in decimal is as follows:

183670992315982423120115083940975887159166493245638675235742454106 002696789801120758056640625.

The decimal expression of exponential function 5¹²³ set as the first preliminary sequence, wherein the first preliminary sequence has a total of 93 digits. For each number in the first preliminary sequence, the uniformity distribution level of decimal numbers {0, 1, 2, . . . , 9} in the sequence can reach 99.43%.

Preferably, a binary code conversion on the decimal numbers of the first preliminary sequence is performed, such that the odd digits in the first preliminary sequence are transformed into “1” and the even digits in the first preliminary sequence are transformed into “0”, and such that the first preliminary sequence is converted into a first binary code sequence. If each number in the first preliminary sequence has an odd number as the code “1” and an even number as the code “0”, the uniformity level of “1” and “0” of the numbers in the first preliminary sequence can even reach 99.79%, in which there are 44 codes “1” and 49 codes “0”. The first binary code sequence is as follows:

101010110111000011001110011001110011111000110010100110111000101000 00010101001100110010000001.

When the uniformity level is closing to 100%, the probability of the code “0” and the code “1” is closing to ½, which is the most perfect random number. More importantly, the random numbers generated by the present invention are highly irrelevant. For example, the two sets of numbers generated by 5¹³² and 5¹³³ are highly irrelevant. In present invention, an integer exponential function is used as the entropy source for the encryption algorithm, it is extremely difficult to be cracked. In the embodiment of the present invention, a decimal exponential function is used to generate a random sequence, and the simulation results show that no matter the base is a prime number or a composite number, when the length of the sequence exceeds 90 digits, the random uniformity exceeds 95.5%. In addition, when it is converted into a binary code, its uniformity can be further improved. Therefore, the first binary code sequence will be more suitable for using as a random number source.

Alternatively, there is another way to process the method. In this embodiment, a binary code conversion on the decimal numbers of the first preliminary sequence is performed, such that the odd digits in the first preliminary sequence are transformed into “0” and the even digits in the first preliminary sequence are transformed into “1”, and such that the first preliminary sequence is converted into a first binary code sequence. Comparing to the embodiment above, the odd digits are transformed into “0” instead of “1”, and the even digits are transformed into “1” instead of “0”.

However, if the value of the exponential function a^{b} is very large, for example, calculating 5¹³² or the larger, the computing load is escalating. It is recommended to use a specially constructed calculator to avoid floating-point overflow or a long calculation time.

Thus, an embodiment of the present invention further provides a method for generating a random sequence using an exponential function as a random number source, comprising: providing at least two sets of exponential functions mⁿ and x^{y}, wherein, the base m and the base x are integers, and the exponent n and the exponent y are integers; expanding a value of mⁿ and a value of x^{y} into a first sequence and a second sequence in decimal, respectively; concatenating the first sequence and the second sequence into a second preliminary sequence; and, using the second preliminary sequence as a random number source to generate a random sequence.

Preferably, the base m and the base x are positive integers, and the exponent n and the exponent y are positive integers. For example, the two sets of the exponential functions mⁿ and x^{y} are 5¹⁵ and 6¹³, respectively.

Then, the decimal expression of the exponential function mⁿ and the decimal expression of the exponential function x^{y} are expanded into a first sequence and a second sequence, respectively. If the exponential function is 5¹⁵=30517578125, the first sequence is {30517578125}, and if the exponential function is 6¹³=13060694016, the second sequence is {13060694016}. The first and second sequences are then concatenated into a second preliminary sequence and expressed as {5¹⁵, 613}, and the second preliminary sequence is expanded to {3051757812513060694016} in decimal expression. Finally, the second preliminary sequence is used as random number source to generate a random sequence.

Preferably, the order in which the first sequence and the second sequence are concatenated can be interchanged. If the order of concatenating the first sequence {30517578125} and the second sequence {13060694016} is reversed, the second preliminary sequence is represented as {1306069401630517578125}. When there are more than two sets of exponential functions, after the value of each exponential function is expanded in decimal expression, the generated sequence can be arbitrarily concatenated into the second preliminary sequence, and the second preliminary sequence also has the same random number source characteristics.

Preferably, the number of digits in the second preliminary sequence may be at least 90 digits. In order to make the numbers in the second preliminary sequence chaotic enough, or to make the distribution of each number in the sequence more natural, or to avoid the value of a single exponential function is too large or too many digits, or to avoid the difficulties in the operation of the calculator, for example, directly calculating 5¹³² or greater, the second preliminary sequence can be serially combined through multiple sets of exponential functions with smaller values or fewer digits, such that the number of digits of the second preliminary sequence is at least 90 digits. In this embodiment, there are eight sets of exponential functions, which are m1ⁿ¹, m1ⁿ², m1ⁿ³, m1ⁿ⁴, m1ⁿ⁵, m1ⁿ⁶, m1ⁿ⁷ and m1ⁿ⁸, wherein m1=5, n1=15, n2=16, n3=17, n4=18, n5=19, n6=20, n7=21, n8=22, and then the values of the eight sets of exponential functions are 5¹⁵, 5¹⁶, 5¹⁷, 5¹⁸, 5¹⁹, 5²⁰, 5²¹ and 5²², respectively. The eight sets of exponential functions are successively concatenated into the second preliminary sequence, which is expressed as {5¹⁵, 5¹⁶, 5¹⁷, 5¹⁸, 5¹⁹, 5²⁰, 5²¹, 5²²} in exponential form. If the second preliminary sequence is expanded in decimal with a total of 107 digits, the effect of the same uniformity level can also be achieved, and its uniformity level can reach 99.24%. This method will save a lot of operation time than calculating 5¹³² directly, and the general computer calculator can do this operation, greatly reducing the complexity and time of the operation, and improving execution efficiency.

Preferably, the binary code conversion on the decimal numbers of the second preliminary sequence is performed, such that the odd digits in the second preliminary sequence are transformed into “1”, and the even digits in the second preliminary sequence are transformed into “0”, and such that the second preliminary sequence is converted into a second binary code sequence. When the second preliminary sequence is converted into the second binary code sequence, its uniformity level can reach 99%. Therefore, the second binary code sequence is more suitable for using as a random number source.

Again, there is another way to process the method. In this embodiment, a binary code conversion on the decimal numbers of the second preliminary sequence is performed, such that the odd digits in the second preliminary sequence are transformed into “0”, and the even digits in the second preliminary sequence are transformed into “1”, and such that the second preliminary sequence is converted into a second binary code sequence.

The spirit of the above embodiment is that when the value of an exponential function is large enough and the number of digits generated by the decimal value are enough, using the value of the exponential function as a random number source is very suitable for using in the field related to the generation of random sequences, such as password protection, encryptor or communication system, etc. In addition, because the value of the exponential function can be pre-set and calculated, it is also very convenient for subsequent retrieval of the original random number source content, and there is no need to worry about the loss of the private key, such as in the block chain. Further, each correlation between index function values is almost unpredictable. It is also difficult for a third party to derive a base and an exponent of an exponential function from the disclosed large exponential field pattern, especially when the large exponential field pattern can be obtained by combining multiple exponential field patterns. Finally, after being converted into a binary code, the difficulty of being cracked can be further increased.

1. A method for generating a random sequence using an exponential function as a random number source, comprising:
providing an exponential function a^{b}, wherein, the base a is an integer, and the exponent b is an integer;
expanding a value of the exponential function into a first preliminary sequence in decimal; and
using the first preliminary sequence as a random number source to generate a random sequence.

2. The method for generating the random sequence using the exponential function as the random number source according to claim 1, wherein, the base a is a positive integer, and the exponent b is a positive integer.

3. The method for generating the random sequence using the exponential function as the random number source according to claim 1, wherein, a number of digits in the first preliminary sequence is at least 90 digits.

4. The method for generating the random sequence using the exponential function as the random number source according to claim 1, further comprising:
performing a binary code conversion on the decimal numbers of the first preliminary sequence, wherein the odd digits in the first preliminary sequence are transformed into “1” and the even digits in the first preliminary sequence are transformed into “0”, such that the first preliminary sequence is converted into a first binary code sequence; and
replacing the first preliminary sequence with the first binary code sequence as the random number source to generate the random binary code sequence.

5. The method for generating the random sequence using the exponential function as the random number source according to claim 1, further comprising:
performing a binary code conversion on the decimal numbers of the first preliminary sequence, wherein the odd digits in the first preliminary sequence are transformed into “0” and the even digits in the first preliminary sequence are transformed into “1”, such that the first preliminary sequence is converted into a first binary code sequence; and
replacing the first preliminary sequence with the first binary code sequence as the random number source to generate the random binary code sequence.

6. A method for generating a random sequence using an exponential function as a random number source, comprising:
providing at least two sets of exponential functions mⁿ and x^{y}, wherein, the base m and the base x are integers, and the exponent n and the exponent y are integers;
expanding a value of mⁿ and a value of x^{y} into a first sequence and a second sequence in decimal, respectively;
concatenating the first sequence and the second sequence into a second preliminary sequence; and
using the second preliminary sequence as a random number source to generate a random sequence.

7. The method for generating the random sequence with the exponential function as the random number source according to claim 6, wherein, the base m and the base x are positive integers, and the exponent n and the exponent y are positive integers.

8. The method for generating the random sequence using the exponential function as the random number source according to claim 6, further comprising: interchanging an order in which the first sequence and the second sequence are concatenated.

9. The method for generating the random sequence using the exponential function as the random number source according to claim 6, wherein, a number of digits in the second preliminary sequence is at least 90 digits.

10. The method for generating the random sequence with the exponential function as the random number source according to claim 6, further comprising:
performing a binary code conversion on the decimal numbers of the second preliminary sequence, wherein the odd digits in the second preliminary sequence are transformed into “1” and the even digits in the second preliminary sequence are transformed into “0”, such that the second preliminary sequence is converted into a second binary code sequence; and
replacing the second preliminary sequence with the second binary code sequence as the random number source to generate the random sequence.

11. The method for generating the random sequence with the exponential function as the random number source according to claim 6, further comprising:
performing a binary code conversion on the decimal numbers of the second preliminary sequence, wherein the odd digits in the second preliminary sequence are transformed into “0” and the even digits in the second preliminary sequence are transformed into “1”, such that the second preliminary sequence is converted into a second binary code sequence; and
replacing the second preliminary sequence with the second binary code sequence as the random number source to generate the random sequence.
